(19) United States
(12) Patent Application Publication
(10) Pub. No.: US 2012/0067081 A1
(43) Pub. Date: Mar. 22, 2012

(54) Process And Plant For Recovering Argon In A Separation Unit For A Purge Gas Used In The Synthesis Of Ammonia

(75) Inventors: Alain Briglia, Corze (FR); Antonie Hernandez, Chatenary Malabry (FR); Bemard Saulnier, La Garenne Colombes (FR); Laurent Samy, Paris (FR); Jean-Marc Tsevery, Lieusaint (FR); Marie-Pascal Victor, Paris (FR)

(73) Assignee: L'Air Liquide Societe Anonyme Pour L'Etude Et L'Exploitatin Des Procedes Georges Claude, Paris (FR)

(21) Appl. No.: 13/375,282

(22) PCT Filed: Jun. 3, 2010
(86) PCT No.: PCT/FR2010/051089

§ 371 Date: Nov. 30, 2011

(30) Foreign Application Priority Data
Jun. 5, 2009 (FR) 0953730

(51) Int. Cl. F25J 3/08; B01D 53/14; F25J 3/02

(52) U.S. Cl. 62/630; 95/186; 96/234

(57) ABSTRACT

A plant for producing an argon-rich stream from a mixture formed by a purge fluid in an ammonia production plant comprises: at least one phase separator; a methane scrubbing column; a methane separation column; a nitrogen/argon separation column; a line for sending the mixture into at least one phase separator, to produce at least a hydrogen-enriched gas and a hydrogen-depleted liquid; a line for sending at least a portion of the hydrogen-depleted liquid into the bottom of the methane scrubbing column, to form an overhead gas and a bottoms liquid; a line for sending at least a portion of the bottoms liquid from the methane scrubbing column to the methane separation column, to produce a methane-enriched bottoms liquid and a methane-depleted overhead gas; a line for sending at least a portion of the methane-depleted overhead gas to the nitrogen/argon separation column, to form a nitrogen-enriched fluid as overhead of said column; a line for withdrawing an argon-rich liquid as bottoms of said column, serving as product; and a line for sending at least a portion of the methane-enriched bottoms liquid to the top of the methane scrubbing column.

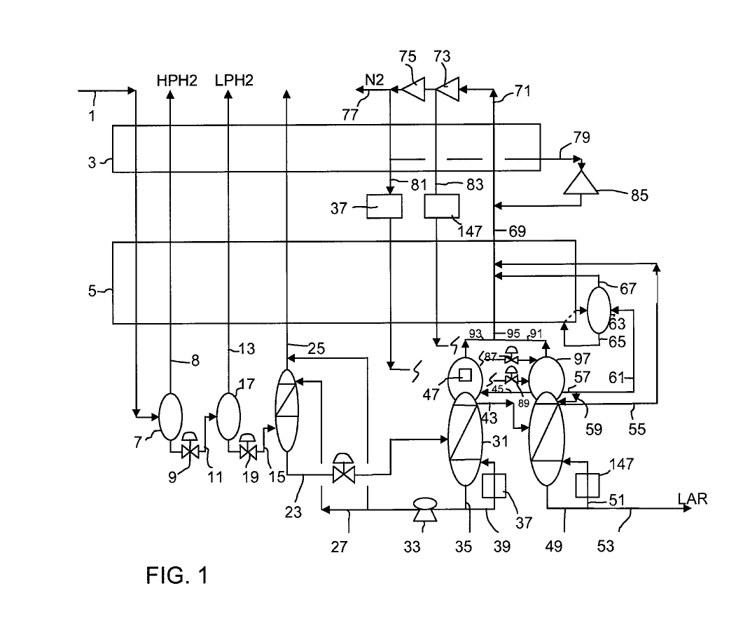

The present invention relates to a process and to a plant for recovering argon in a separation unit for a purge gas from the synthesis of ammonia.

A conventional plant for producing ammonia by natural gas reforming generally comprises the following steps:
final desulfurization of the natural gas,
primary reforming,
postcombustion in air, with which the nitrogen for the synthesis is introduced,
conversion of CO,
decarbonation,
methanization,
compression,
ammonia synthesis loop.

In order to remove the inert species and prevent them accumulating in the system, the ammonia synthesis loop produces a purge gas which contains the following compounds: H₂, N₂, CH₄, Ar, NH₃. The mixture is substantially free of carbon monoxide but may or may not contain helium.

It may then be advantageous to treat this purge in a cryogenic unit in order to recover, on the one hand, the compounds that can be upgraded in the ammonia synthesis loop and, on the other hand, to produce argon in liquid form and to sell it.

“Production and Purification of Argon” by Arregger, Chemical and Process Engineering, October 1964, U.S. Pat. No. 4,338,108, “Cryogenic Gas Separation” by Duckett et al., The Chemical Engineer, December 1985, “Methods for argon recovery to meet increased demand on the argon market” by Springmann, AIChE Symposium Series 1982, U.S. Pat. No. 4,762,542, “Separation of Gases” by Isalski, pp. 84-88 and “Cryogenic Argon Recovery from Ammonia Plant Purge Gas” by Hwang et al., presented at “Cryogenics and Refrigeration”, Hangzhou, 1989 all disclose the use of a nitrogen scrubbing column in a process for the cryogenic separation of a purge gas from the synthesis of ammonia in order to produce argon. This column is generally followed by an argon/methane separation column and a nitrogen/argon separation column.

According to one subject of the invention, a process is provided for producing an argon-rich stream from a mixture formed by a purge fluid from a plant for producing ammonia and that contains hydrogen, methane, nitrogen and hydrogen in which:

i) the mixture is separated by at least one phase separator in order to produce at least one hydrogen-enriched gas and one hydrogen-depleted liquid,

ii) at least one portion of the hydrogen-depleted liquid is sent to the bottom of a methane scrubbing column in order to form an overhead gas and a bottom liquid,

iii) at least one portion of the bottom liquid of the methane scrubbing column is sent to a methane separation column in order to produce a methane-enriched bottom liquid and a methane-depleted overhead gas,

iv) at least one portion of the methane-depleted overhead gas is sent to a nitrogen/argon separation column in order to form a nitrogen-enriched fluid at the top of the column and an argon-rich liquid at the bottom of the column that is used as the product, and

v) at least one portion of the methane-enriched bottom liquid is sent to the top of the methane scrubbing column.

According to other optional features:

step i) comprises the separation of the mixture in at least two phase separators in series, the liquid from the first separator being expanded and sent to the second separator and the liquid from the second separator forming the fluid for feeding to the bottom of the methane scrubbing column, each phase separator producing a hydrogen-enriched gas;

the first phase separator produces a hydrogen-enriched gas at higher pressure than the second phase separator;

the methane-enriched liquid is pressurized upstream of the methane scrubbing column;

the process kept cold at least partially by a nitrogen cycle;

the purge fluid contains no helium.

According to another subject of the invention, a plant is provided for producing an argon-rich stream from a mixture formed by a purge fluid from a plant for producing ammonia and that contains hydrogen, methane, nitrogen and hydrogen, comprising at least one phase separator, a methane scrubbing column, a methane separation column, a nitrogen/argon separation column, a line for sending the mixture into at least one phase separator in order to produce at least one hydrogen-enriched gas and one hydrogen-depleted liquid, a line for sending at least one portion of the hydrogen-depleted liquid to the bottom of the methane scrubbing column in order to form an overhead gas and a bottom liquid, a line for sending at least one portion of the bottom liquid from the methane scrubbing column to the methane separation column in order to produce a methane-enriched bottom liquid and a methane-depleted overhead gas, a line for sending at least one portion of the methane-depleted overhead gas to the nitrogen/argon separation column in order to form a nitrogen-enriched fluid at the top of the column, a line for withdrawing an argon-rich liquid at the bottom of the column that is used as the product and a line for sending at least one portion of the methane-enriched bottom liquid to the top of the methane scrubbing column.

Optionally, the plant comprises:

at least two phase separators in series, a valve for expanding the liquid from the first separator, a line for sending the liquid from the first separator to the valve, a line for sending the liquid expanded by the valve to the second separator and a line for sending the liquid from the second separator forming the fluid for supplying the bottom of the methane scrubbing column and lines for withdrawing a hydrogen-enriched gas from each phase separator;

a bottom reboiler for the nitrogen/argon separation column;

a bottom reboiler for the methane separation column;

an overhead condenser for the methane separation column;

no overhead condenser for the nitrogen/argon separation column;

no bottom reboiler for the methane scrubbing column;

means for pressurizing the methane-enriched liquid upstream of the methane scrubbing column;

a nitrogen cycle, for example for ensuring the reboiling of at least one of the columns and/or the cooling of the overhead condenser of the nitrogen/argon separation column.

The invention consists in using a methane scrubbing column at relatively low pressure in order to be able to simultaneously lower the hydrogen content in the liquid phase at the bottom of the column and thus to lower the hydrogen content in the nitrogen cycle and also to increase the efficiency of the recovery of argon in the liquid phase and therefore of the whole of the unit (increase in efficiency of around 5%).

It has been discovered that a methane scrubbing was more effective than a nitrogen scrubbing and also avoids sending nitrogen into the overhead gas of the column on the outside.

The invention will be described in greater detail by referring to the FIGURE which illustrates a plant according to the invention.

A mixture of hydrogen, carbon monoxide, methane, nitrogen and argon 1, substantially free of carbon monoxide and preferably substantially free of helium, is cooled in a first heat exchanger 3 and then in a second heat exchanger 5 where it partially condenses. The partially condensed stream is sent into a first phase separator 7. The gas 8 from the first phase separator, enriched with hydrogen, is sent to the two exchangers 5, 3 in order to be reheated therein. The liquid from the first phase separator is expanded in a valve 9 in order to partially vaporize and the partially vaporized stream 11 is sent into a second phase separator 17. The gas 13 from the second phase separator, enriched in hydrogen, is sent to the two exchangers 5, 3 in order to be reheated therein. The liquid from the first phase separator is expanded in a valve 19 in order to partially vaporize and the partially vaporized stream 15 is sent to the bottom of a methane scrubbing column 21 supplied at the top with a stream of liquid methane 27.

The overhead gas from the methane scrubbing column is mixed with a stream 29 in order to form the stream 25 and the stream 25 is reheated in the two exchangers 5, 3 in order to form a fuel gas. The bottom liquid 23 is expanded in a valve then sent to an intermediate level of a methane separation column 31. The bottom liquid 35 from this column 31 is pressurized by a pump 33 and sent partly (stream 27) to the top of the scrubbing column 21 and partly (stream 29) mixed with the overhead gas from the scrubbing column. The column 31 has a bottom reboiler 37 supplied by a bottom stream 39 from the column 31. The column 31 also has an overhead condenser 47 where the overhead gas enriched in nitrogen and in argon condenses. An overhead gas stream 43 is sent to an intermediate level of the column 41. The column 41 has a bottom reboiler 147 and an overhead nitrogen storage 97. The bottom liquid 49 is sent partly (stream 51) to the bottom reboiler 147 and the rest 53 is used as the argon-rich liquid product. The overhead gas 55 from the column 41 rich in nitrogen is sent to an intermediate level of the exchanger 5.

A nitrogen cycle ensures the reboiling of columns 31, 41 and the cooling of the overhead condenser 47 and provides the cooling of the top of the column 41 by direct reflux. Nitrogen 71 is compressed in a compressor 73 and divided into two. One portion is sent to the compressor 75 in order to form the high-pressure nitrogen product 77 and a high-pressure cycle stream. The cycle stream is cooled to an intermediate temperature of the exchanger 3 then is divided into two. One portion 1 is used to heat the reboiler 37 then is sent to storage through the valve 89. Another portion 79, at an intermediate temperature of the exchanger 3, is expanded in a turbine 85 and mixed with the stream 69 in order to form the stream 71. The nitrogen from the compressor 73 is used for reboiling the reboiler 147 as stream 83, then is expanded by the valve 87 and sent to storage 97. The storage liquid is withdrawn as two streams, the stream 47 being sent to the overhead condenser 47 and the other stream 57 being partly (59) sent back to the column 41 and partly (61) sent to a phase separator 63. The gas from the phase separator is mixed with streams 93, 91 coming respectively from the overhead condenser 47 and from the storage 97. This mixed stream is reheated in the exchanger 5, is mixed with the stream 55 and forms the stream 69. The liquid 65 from the phase separator 63 is reheated in the exchanger 5.

The first phase separator 7 may be replaced by a nitrogen scrubbing column. Optionally, the process may comprise a single phase separator upstream of the column 21, but the performances will be worse.

1-10. (canceled)

11. A process for producing an argon-rich stream from a mixture formed by a purge fluid from a plant for producing ammonia and that contains hydrogen, methane, nitrogen and hydrogen, the process comprising:
a) separating the mixture with at least one phase separator, thereby producing at least one hydrogen-enriched gas and one hydrogen-depleted liquid,
b) sending at least one portion of the hydrogen-depleted liquid to the bottom of a methane scrubbing column, thereby forming an overhead gas and a bottom liquid,
c) sending at least one portion of the bottom liquid of the methane scrubbing column to a methane separation column in order to produce a methane-enriched bottom liquid and a methane-depleted overhead gas,
d) sending at least one portion of the methane-depleted overhead gas to a nitrogen/argon separation column in order to form a nitrogen-enriched fluid at the top of the column and an argon-rich liquid at the bottom of the column that is used as the product, and
e) sending at least one portion of the methane-enriched bottom liquid to the top of the methane scrubbing column.

12. The process of claim 11, in which step a) further comprises the separation of the mixture in at least two phase separators in series, the liquid from the first separator being expanded and sent to the second separator and the liquid from the second separator forming the fluid for feeding to the bottom of the methane scrubbing column, with each phase separator producing a hydrogen-enriched gas.

13. The process of claim 12, in which the first phase separator produces a hydrogen-enriched gas at higher pressure than the second phase separator.

14. The process of claim 11, in which the methane-enriched liquid is pressurized upstream of the methane scrubbing column.

15. The process of claim 11, wherein any refrigeration necessary is at least partially provided by a nitrogen cycle.

16. The process of claim 11, wherein the purge fluid contains no helium.

17. A plant for producing an argon-rich stream from a mixture formed by a purge fluid from a plant for producing ammonia and that contains hydrogen, methane, nitrogen and hydrogen, comprising at least one phase separator, a methane scrubbing column, a methane separation column, a nitrogen/argon separation column, a line for sending the mixture into at least one phase separator in order to produce at least one hydrogen-enriched gas and one hydrogen-depleted liquid, a line for sending at least one portion of the hydrogen-depleted liquid to the bottom of the methane scrubbing column in order to form an overhead gas and a bottom liquid, a line for sending at least one portion of the bottom liquid from the methane scrubbing column to the methane separation column in order to produce a methane-enriched bottom liquid and a methane-depleted overhead gas, a line for sending at least one portion of the methane-depleted overhead gas to the nitrogen/argon separation column in order to form a nitrogen-enriched fluid at the top of the column, a line for withdrawing an argon-rich liquid at the bottom of the column that is used as the product and a line for sending at least one portion of the methane-enriched bottom liquid to the top of the methane scrubbing column.

18. The plant in claim 17, further comprising at least two phase separators in series, a valve for expanding the liquid from the first separator, a line for sending the liquid from the first separator to the valve, a line for sending the liquid expanded by the valve to the second separator and a line for sending the liquid from the second separator forming the fluid for supplying the bottom of the methane scrubbing column and lines for withdrawing a hydrogen-enriched gas from each phase separator.

19. The plant in claim 17, further comprising means for pressurizing the methane-enriched liquid upstream of the methane scrubbing column.

20. The plant in claim 17, further comprising a nitrogen cycle.
